(19) United States
(12) Patent Application Publication
(10) Pub. No.: US 2026/0118525 A1
(43) Pub. Date: Apr. 30, 2026

(54) RENEWABLE BIO-POLYMER BASED SOLID-STATE GAMMA RADIATION DETECTOR-DOSIMETER

(71) Applicant: Purdue Research Foundation, West Lafayette, IN (US)

(72) Inventor: Rusi P. Taleyarkhan, Lafayette, IN (US)

(21) Appl. No.: 19/057,111

(22) Filed: Feb. 19, 2025

Related U.S. Application Data
(60) Provisional application No. 63/556,481, filed on Feb. 22, 2024.

(51) Int. Cl. G01T 1/12; G01T 1/29; G01T 3/04; G21C 17/00

(52) U.S. Cl. CPC G01T 1/12; G01T 1/2914; G01T 3/04; G21C 17/00

(57) ABSTRACT

Methods of measuring a radiation dose implement and/or comprise measuring a first value of a mass of a sample, wherein the sample includes a polylactic acid (PLA) resin, and wherein the sample has been subjected to the radiation dose; immersing the sample in a solvent at a predetermined temperature for a first predetermined period of time; removing the sample from the solvent after the first predetermined period of time has elapsed; measuring a second value of the mass of the sample; and outputting a measurement of the radiation dose based on the first value and the second value.

### CROSS-REFERENCE TO RELATED APPLICATIONS

This application claims priority to and the benefit of the U.S. Provisional Patent Application No. 63/556,481, filed Feb. 22, 2024 and titled “Solid-State Gamma Radiation Detector-Dosimeter Systems and Methods,” the entire contents of which are herein incorporated by reference for all purposes.

### STATEMENT REGARDING FEDERALLY SPONSORED RESEARCH OR DEVELOPMENT

This invention was made with government support under 89303321CEM000080 awarded by the Department of Energy. The government has certain rights in the invention.

### TECHNICAL FIELD

The present disclosure is directed to a system and method to determine irradiation dose through correlation of changes in the properties of polylactic acid (PLA) when subject to ionizing nuclear radiation. More particularly, the present disclosure is directed to a dosimeter composed of PLA beads.

### BACKGROUND

Neutron and/or gamma radiation monitoring and related dosimetry have applications in a variety of areas ranging from nuclear power reactor monitoring (under extreme conditions), personnel radiation safety, nuclear medicine/therapy, food preservation, sterilization, etc. A range of differing instrumentation techniques have been developed; these comparative approaches generally rely on sensors based on counting charge buildup in ionized gases/solids (such as fission chambers or ion chambers) or monitoring light flashes from induced scintillation and thermoluminescence. Comparative systems range from complex and bulky spectrometers costing millions of dollars, to portable survey meters costing thousands to tens of thousands of dollars, to personnel dosimeters costing from tens to hundreds of dollars. These comparative systems, aside from having such a high cost, suffer from additional drawbacks. For example, different techniques and instruments are deployed for neutron (neutral particles) and gamma radiation monitoring. While gamma radiation detectors and dosimeters are more common, neutron detection and dosimetry are much more complex, especially for monitoring fission power generation in commercial power reactors.

### SUMMARY

The present disclosure presents a technology that addresses these and other shortcomings in the comparative systems, and presents a low-cost, rapid turnaround, simple to deploy sensor system that can be used to detect and monitor both the neutron and gamma radiation fields even under extreme radiation and thermal fields, such as those encountered in nuclear power reactors.

According to one aspect of the present disclosure, a method for measuring a radiation dose is presented. The method comprises measuring a first value of a mass of a first sample, wherein the first sample includes a polylactic acid (PLA) resin, and wherein the first sample has been subjected to the radiation dose at a testing area; immersing the first sample in a solvent at a first predetermined temperature for a first predetermined period of time; removing the first sample from the solvent after the first predetermined period of time has elapsed; measuring a second value of the mass of the first sample; and generating a first measurement of the radiation dose based on the first value and the second value of the mass of the first sample.

According to another aspect of the present disclosure, a method for mapping a radiation dose is presented. The method comprises preparing a plurality of samples, wherein the plurality of samples respectively include a polylactic acid (PLA) resin; subjecting the plurality of samples to a radiation environment; for each of the plurality of samples: measuring a first value of a mass of the sample, immersing the sample in a solvent at a predetermined temperature for a predetermined period of time, removing the sample from the solvent after the predetermined period of time has elapsed, measuring a second value of the mass of the sample, and determining a ratio of mass dissolved of the sample; and generating a map of the radiation dose based on respective ratios of mass dissolved for the plurality of samples and on respective locations within the radiation environment for the plurality of samples.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 illustrates example PLA resin beads according to various aspects of the present disclosure.

FIG. 2 illustrates a relative gamma dose map for an irradiator according to various aspects of the present disclosure.

FIG. 3 illustrates example dose variation results according to various aspects of the present disclosure.

FIG. 4 illustrates an example schematic of a sample capsule assembly according to various aspects of the present disclosure.

FIG. 5 illustrates an example thermal neutron flux according to various aspects of the present disclosure.

FIG. 6 illustrates an example total neutron flux according to various aspects of the present disclosure.

FIG. 7 illustrates example mass dissolution results according to various aspects of the present disclosure.

FIG. 8A illustrates example mass dissolution study setups according to various aspects of the present disclosure.

FIG. 8B illustrates an example mass dissolution study setup according to various aspects of the present disclosure.

FIG. 9 illustrates example mass dissolution results according to various aspects of the present disclosure.

FIG. 10 illustrates example mass dissolution results according to various aspects of the present disclosure.

FIG. 11 illustrates example mass dissolution results according to various aspects of the present disclosure.

FIG. 12 illustrates example mass dissolution results according to various aspects of the present disclosure.

FIG. 13 illustrates example mass dissolution results according to various aspects of the present disclosure.

FIG. 14 illustrates an example method according to various aspects of the present disclosure.

### DETAILED DESCRIPTION

The detailed description set forth below in connection with the appended drawings is intended as a description of various configurations and is not intended to represent the only configurations in which the subject matter described herein may be practiced. The detailed description includes specific details to provide a thorough understanding of various aspects of the present disclosure. However, it will be apparent to those skilled in the art that the various features, concepts, and aspects described herein may be implemented and practiced without these specific details.

Before any aspects of the invention are explained in detail, it is to be understood that the invention is not limited in its application to the details of construction and the arrangement of components set forth in the following description or illustrated in the following drawings. The invention is capable of other aspects and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

It is also to be understood that any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed or that the first element must precede the second element in some manner.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as, e.g., “either,” “one of,” “only one of,” or “exactly one of.” Further, a list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of each of A, B, and C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C. In general, the term “or” as used herein only indicates exclusive alternatives (e.g., “one or the other but not both”) when preceded by terms of exclusivity, such as, e.g., “either,” “one of,” “only one of,” or “exactly one of.”

The present disclosure includes a description of various methods. For any methods described, regardless of whether the method is described in conjunction with a flow diagram, it should be understood that unless otherwise specified or required by context, any explicit or implicit ordering of steps performed in the execution of a method does not necessarily imply that those steps must be performed in the order presented, but instead the steps may be performed in a different order and/or in parallel.

The following discussion is presented to enable a person skilled in the art to make and use aspects of the invention. Various modifications to the illustrated aspects will be readily apparent to those skilled in the art, and the generic principles herein can be applied to other aspects and applications without departing from aspects of the invention. Thus, aspects of the invention are not intended to be limited to aspects shown but are to be accorded the widest scope consistent with the principles and features disclosed herein. The following detailed description is to be read with reference to the figures, in which like elements in different figures have like reference numerals. The figures, which are not necessarily to scale, depict selected aspects and are not intended to limit the scope of aspects of the invention. Skilled artisans will recognize the examples provided herein have many useful alternatives and fall within the scope of aspects of the invention.

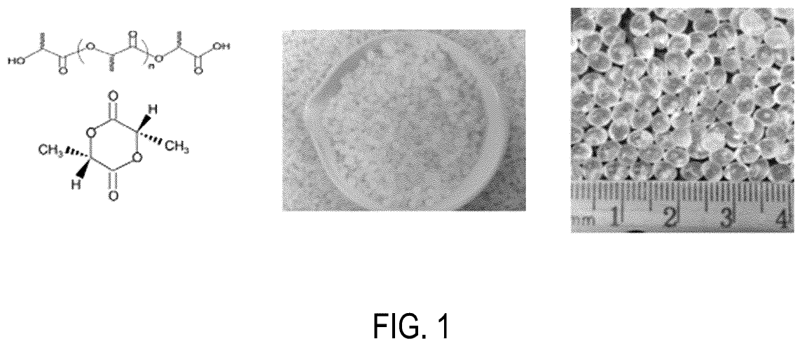

Ionizing radiation interaction leads to chain scission of polymers, including for the biopolymer PLA; this is followed by a physio-chemical property changes, including degradation of material properties such as strength, optical transmissivity, and dissolution. FIG. 1 illustrates the molecular formula and physical characteristics of PLA resin beads. In particular, FIG. 1 illustrates, at left, the PLA molecular structure; at center, ˜3 mm resin beads in a cup; and at right, a closeup with scale.

One positive feature of PLA is its “green” characteristic and ability to be tailored for a wide range of potential applications via ionizing radiation or other means, such as thermal treatment. PLA resins have been investigated via photon-electron radiation to advance the field of radiation instrumentation. One example implementation of PLA resins is as part of a PLA-based solid-state radiation detector/dosimeter (PLAD). PLA presents a promising material for use even in harsh nuclear environments, such as within the core of operating light water reactors (LWRs) and accelerator-based systems. The systems and methods set forth herein advance PLAD to achieve a nonpowered solid-state, ultra-lightweight-scalable (e.g., ˜0.1+g (4 mm)/detector), affordable (e.g., <$0.10/unit), environmentally friendly, easy-to-use, general purpose and real-time gamma-beta-alpha-fission-neutron monitor that is also readily deployable in extreme (e.g., 106+R/h), mixed radiation fields such as would be found in LWRs. The methods set forth herein may be executed using available laboratory equipment, decipher for both neutron and photon radiation types, are effective over a practically extensive range of radiation levels (e.g., 1-100 kGy), and are capable of being deployed under harsh thermal-hydraulic conditions such as in ˜300° C. within the coolant field of LWRs.

In one example implementation, the PLAD technique set forth herein utilizes the ready dissolution of PLA in a solvent such as acetone, which occurs in an accelerated fashion with increasing solvent temperature. The fractional dissolution of PLA resin beads when placed within an acetone bath at various temperatures (e.g., ˜50° C., chosen in one example as being at a level a few degrees below the boiling point of acetone) was examined. Surprisingly, scoping trials revealed a reproducible linear increase over the 0-100 Gy dose range using PLA resin beads irradiated with 1.2-1.3 MeV gamma photons. More systematic studies were performed, including an assessment of the potential for monitoring neutron radiation in mixed neutron-gamma radiation fields inside of a fission nuclear reactor.

The present disclosure sets forth a PLAD technique that measures the mass-loss ratio of PLA by dissolution (MLD) in a solvent, such as acetone, for use in photon and neutron dosimetry monitoring. As will be described in more detail below, this PLAD-MLD technique was investigated by irradiating PLA resin in a gamma-only radiation irradiator and separately within an operating fission nuclear research reactor which offered a complex mixture of neutrons and gamma radiation fields spanning an extensive range of energies (10⁻² eV to 20 MeV).

In support of the present disclosure, experimentation was performed based on the irradiation of PLA samples with gamma radiation and mixed-field gamma-neutron radiation. This effort aimed to assess the combined and individual effects of absorbed gamma and neutron radiation types, respectively. As such, two types of irradiation sources were utilized: (1) a Co-60 irradiator emitting ˜1.1 MeV and ˜1.2 MeV gamma photons; and (2) a nuclear fission reactor, which provided a complex energy spectrum combination of neutrons and gamma photon radiation types.

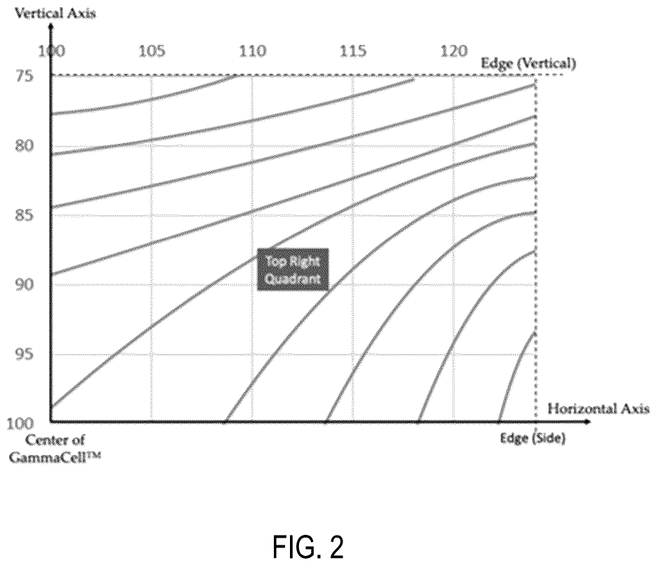

As the Co-60 gamma source, Purdue University's Nordion GammaCell 220™ Co-60 irradiator was used. The irradiator performed y photon irradiation of PLA resin samples procured from NatureWorks, LLC. The average dose in the GammaCell™ was initially calibrated with Fricke Dosimetry in 1993. The dose rates extending to the usage time were evaluated based on the half-life decay of Co-60 source. The accuracy of the estimated dose rate is +0.56% at the 95% confidence limit. By the time the irradiations were performed, the achievable dose rates were ˜2 kGy/day. The dose map within the irradiator is based on data provided by the manufacturer, and is plotted in FIG. 2. In particular, FIG. 2 shows isodose curves (relative dose at center) for the GammaCell™ Co-60 irradiator.

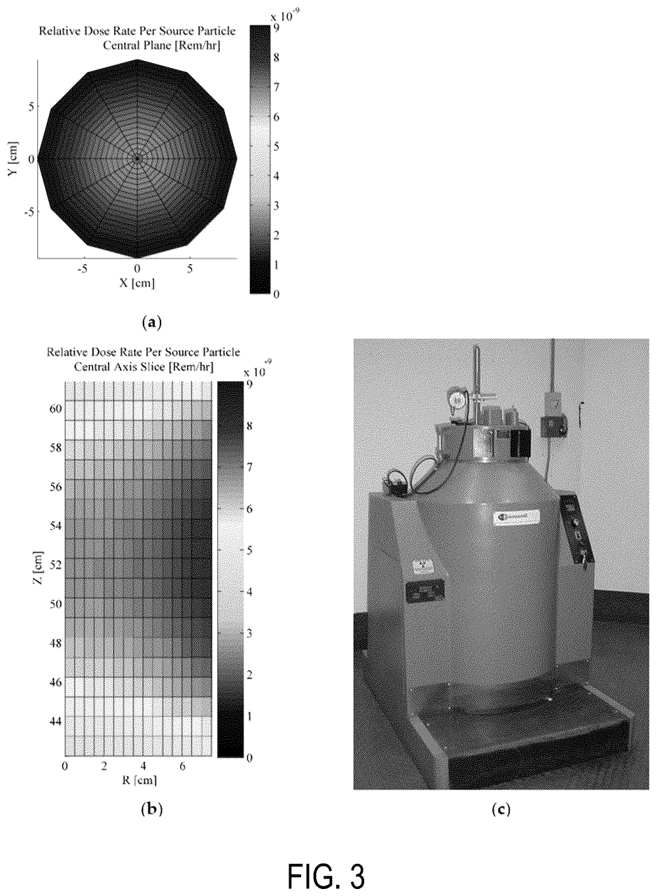

The Monte-Carlo Nuclear Particle (MCNP) code was used to simulate the irradiator internals and to characterize the irradiator core for its spatial radiation dose rate profile, the results of which were used to guide the positioning of samples used for the experiments performed in support of the present disclosure. FIG. 3 illustrates the results of dose variations within radial (from the centerline) and axial locations within the irradiator. In particular, graph (a) of FIG. 3 shows the mid-section axial results, and graph (b) shows the R-Z slice radial results. PLA resins were irradiated in the presence of room air. The maximum dose was 114.4 kGy. Image (c) of FIG. 3 shows the irradiator itself. Both evaluations found that the dose rate at the wall (close to the Co-60 samples) was about 20% higher than at the center. For these experiments, the PLA resin-bearing samples were always kept in the central region of the chamber.

Considering the 5.3 y half-life for Co-60 decay over time, the gamma doses were evaluated by multiplying the time-averaged dose rate over the irradiation duration by the irradiation time. The dose evaluated from Fricke dosimetry was then converted to the real-time gamma radiation dose absorbed by PLA. This is deemed to be appropriate because the mass absorption coefficient (provided by the National Institute of Standards and Technology (NIST) database) of ferrous sulfate, the main component of standard Fricke dosimetry, is very close to that for which PLA exposed to 1.25 MeV photons (the average of 1.17 and 1.33 MeV energies for Co-60 photons): 0.02955 cm²/g for ferrous sulfate, and 0.02816 cm²/g for PLA. Using the GammaCell™ irradiator, PLA resin beads were subjected to accumulated dose levels ranging from 1 to ˜100 kGy.

As the mixed gamma and neutron source, Purdue University's 12-kW pool-type (PUR-1) research nuclear reactor was used. PUR-1 operates as a pool-type reactor under ˜0.1 MPa/20° C. type thermal-hydraulic conditions and offers a neutron-gamma flux field in the range of ˜10¹⁰/cm²-s. Nuclear reactors present a complex irradiation environment, including the predominant neutron and gamma radiation fields and the short-range fission fragments-alpha-beta-neutrino particles from nuclear reactions and secondary radiation. When samples are placed in research reactor ports, the primary radiation types are neutrons and gamma photons.

Four sample irradiation ports in PUR-1 were utilized for this experiment: two around the central area and two at the edge, each containing 7 aluminum capsules (an example of a sample assembly in accordance with the present disclosure). PUR-1 operational power during these irradiations was ˜8 kW. The PUR-1 organization has developed a core simulation tool based on the MCNP code to predict the reactor's neutron/gamma energy flux distributions and estimate the absorbed dose.

The PUR-1 power level was maintained at 8 kW for the entire range of time in the reactor from when the capsules were first loaded to when they were removed. Additionally, it was noticed that the aluminum capsules within which the samples were irradiated exhibited negligibly low neutron activation dose rates of <10⁻³ Gy/h (0.1 R/hr) upon removal of the capsules after in-reactor irradiation.

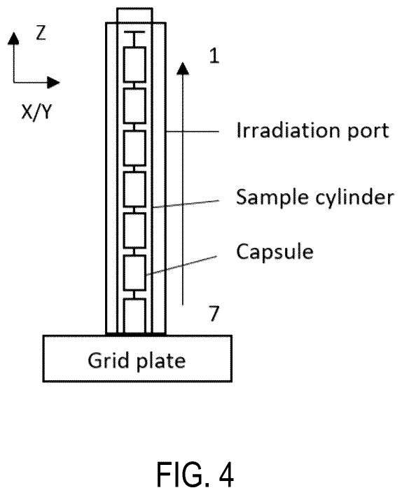

PLA 4043D® (crystalline form) resin beads (see FIG. 1) supplied by Nature Works, LLC were filled into individual aluminum capsules; the capsules were then stacked in a sample cylinder tube which is then inserted into the irradiation port holder tube of the reactor core. The schematic for a sample capsule assemblage (along the X/Y-Z plane) is shown in FIG. 4. The irradiation port rests on the grid plate at the bottom of the core. In the test performed in support of the systems methods described herein, the capsule dimensions were: interior height of 5.4737, interior diameter of 2.2098 cm, external height of 7.8486 cm, and exterior diameter of 2.54 cm; and the irradiation port dimensions were: height of 70.644 cm, interior diameter of 2.66 cm, and exterior diameter of 2.87 cm.

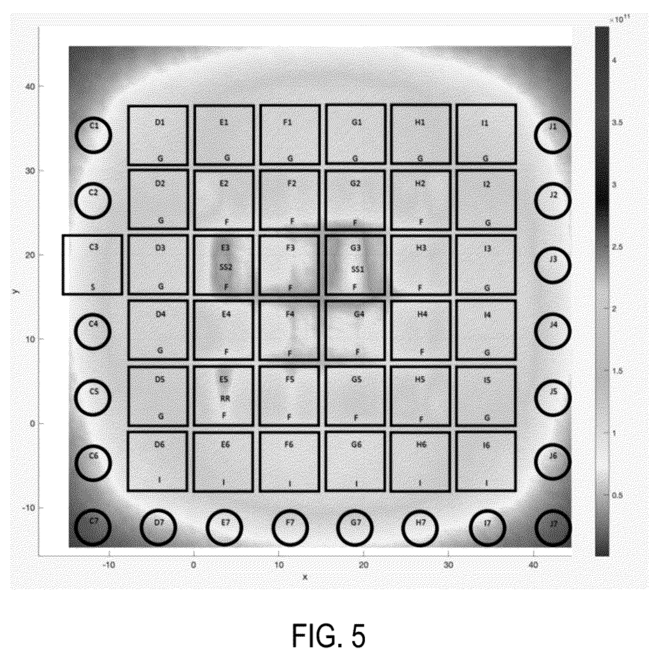

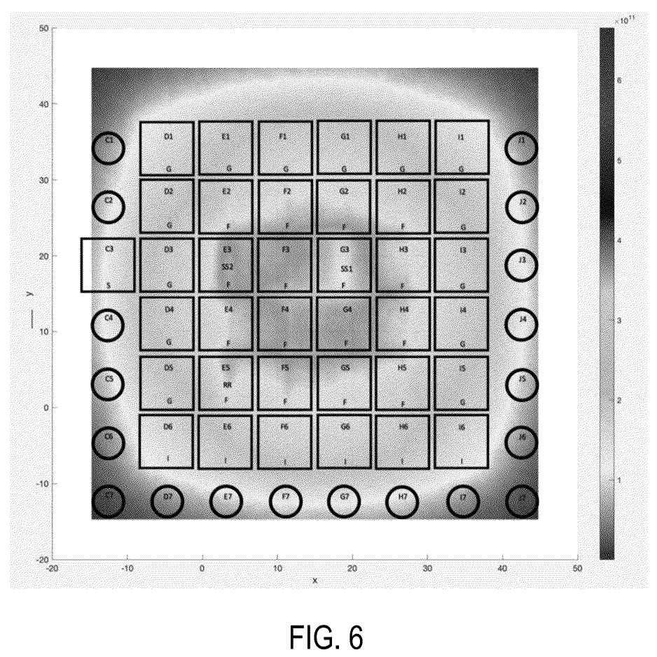

Although 7 capsules (capsules 1-7) were irradiated in total, only 6 of them were filled with PLA resin because the one on the very top (#1) was directly adjacent to the upper free boundary surface where the neutron-gamma fluxes and dose estimations are difficult to estimate with good accuracy. Consequently, the first (#1) capsule was kept empty. The flux profile and dose evaluations were done by MCNP code-based modeling. The X-Y midplane's thermal and total neutron flux (n/cm²/s) profiles are color-coded (10¹⁰-10¹¹ n/cm²/s) in FIGS. 5 and 6, respectively. From practical considerations, the PUR-1 irradiation was conducted over 6 hours, during which the maximum total (gamma and neutron) absorbed dose was ˜40 kGy.

From FIGS. 5 and 6, it can be seen that the average fast-to-thermal neutron flux ratio is about 2:1. Radial port locations D6, F6, G6, and I6, marked with a star (★) in FIG. 6, were available and used for irradiation. As noted above, 7 capsules were loaded in each location (D, F, G, and I, respectively).

The calculated neutron and gamma radiation absorbed doses evaluated for each PLA resin-bearing capsule are listed in Table 1. In Table 1, the location corresponds to the grid location of FIGS. 5 and 6 (before the comma) and the cylinder location within the capsule of FIG. 4 (after the comma). It is noted that for the irradiation port locations D and I towards the left and right of the center of the core, the total dose levels range from ˜9 kGy to ˜17 kGy, respectively. The total dose levels are higher for the central irradiation port locations G and F, ranging from ˜20 kGy to ˜40 kGy, respectively. The neutron dose is derived primarily from fast (MeV), not thermal (eV) energy neutrons; this is to be expected as the PLA resin beads were not doped (e.g., with B) in this experiment. The gamma-to-neutron dose ratio is ˜2:1 for total doses <20 kGy, and gradually approaches ˜1:1 for capsules where the total dose is >20 kGy. This is also expected due to neutron leakage at edges and from the increased neutron-based fission rate in the central regions of the core.

TABLE 1
Calculated neutron, gamma, and total dose for each capsule

| Location | kGy (n) | kGy (γ) | kGy (n, γ) |
|---|---|---|---|
| D6, 2 | 4.13 | 7.80 | 11.93 |
| D6, 3 | 5.54 | 10.12 | 15.65 |
| D6, 4 | 6.06 | 10.90 | 16.96 |
| D6, 5 | 5.72 | 10.37 | 16.09 |
| D6, 6 | 4.52 | 8.57 | 13.09 |
| D6, 7 | 2.86 | 6.08 | 8.94 |
| F6, 2 | 12.03 | 15.82 | 27.85 |
| F6, 3 | 16.57 | 20.36 | 36.93 |
| F6, 4 | 18.18 | 22.60 | 40.78 |
| F6, 5 | 17.18 | 21.29 | 38.47 |
| F6, 6 | 13.73 | 17.54 | 31.27 |
| F6, 7 | 8.24 | 11.88 | 20.12 |
| G6, 2 | 12.80 | 15.84 | 28.63 |
| G6, 3 | 17.00 | 20.72 | 37.72 |
| G6, 4 | 18.83 | 22.73 | 41.56 |
| G6, 5 | 18.06 | 21.79 | 39.85 |
| G6, 6 | 14.31 | 17.80 | 32.11 |
| G6, 7 | 8.74 | 12.06 | 20.80 |
| I6, 2 | 4.64 | 8.18 | 12.82 |
| I6, 3 | 6.21 | 10.48 | 16.68 |
| I6, 4 | 6.84 | 11.13 | 17.97 |
| I6, 5 | 6.58 | 10.69 | 17.27 |
| I6, 6 | 5.29 | 8.91 | 14.21 |
| I6, 7 | 3.23 | 6.38 | 9.62 |

Having performed irradiations for gamma-only fields in the Co-60 irradiator and combined neutron-gamma fields in PUR-1, the irradiated PLA samples were subjected to a detection technique that was developed to rapidly and using simple tools measure not only the total absorbed dose but also to investigate for the potential to differentiate between and identify the dose received from neutron versus gamma photon radiation.

Experiments were performed involving PLA and acetone (a common laboratory cleaning solvent) and showed that acetone (C₃H₆O) dissolves PLA resins—an effect of increased acetone temperature. This observation was further examined for utility for gamma radiation dosimetry through scoping tests to assess the degree of PLA mass dissolution when placed in an acetone-bearing glass beaker in a temperature-controlled water bath for ˜20 minutes at 50° C. (chosen to be close to but under the boiling point of 56.2° C. at 0.1 MPa). The ratio of mass dissolved to the initial starting group (RMD) is given by the following Equation (1), where Ama refers to the mass difference between the initial sample of PLA beads (in this experiment, ten PLA beads) and the remaining PLA after dissolution, and where mod refers to the initial mass of the sample of PLA beads before dissolution.

$$R M D = \frac{Δ {m}_{d}}{{m}_{0 d}} \qquad ( 1 )$$

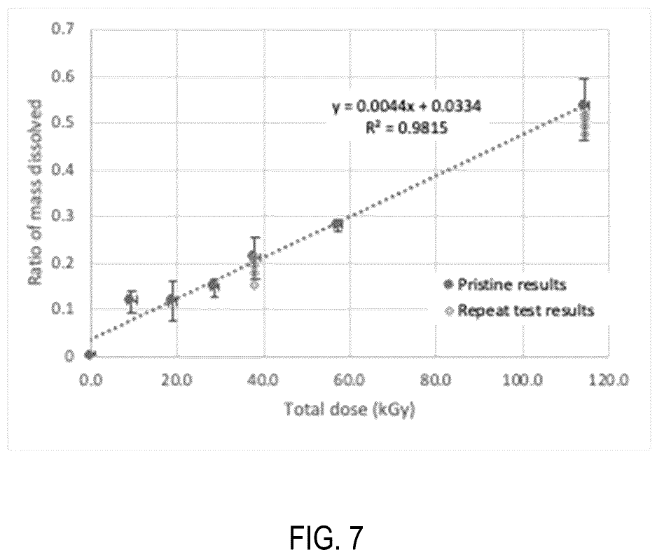

The results of these (pristine) scoping tests with Co-60 gamma irradiated PLA resin over a wide 0-114 kGy dose range are plotted in FIG. 7. Note that 0 kGy dose implies un-irradiated PLA at which, as well, experiments for RMD determination were conducted. At each dose level, three experiments were conducted. The error bars in FIG. 7 depict the range of data from the mean value. In order to check for reproducibility, limited experiments were conducted independently (after a gap of several months) with ˜38 kGy and ˜117 kGy irradiated PLA samples using the same overall setup as for the earlier (pristine) tests. Results of the repeat tests (open diamonds) indicate that the pristine data are generally reproducible and overlap the original data, albeit with a slight bias towards a lower RMD (which may be attributed to a likely acetone bath temperature undershoot by about 0.5° C. based on further studies described in more detail below). Overall, the data exhibit a linear trend for gamma dose levels ranging between 0-117 kGy, as depicted in FIG. 7. Following the scoping test findings of FIG. 7, a systematic protocol and approaches were examined to detect gamma-only and more complex mixed neutron-gamma irradiation doses. The various steps leading to a testing protocol are described below.

PLA resin beads supplied by Nature Works, LLC can vary in size and mass. Because mass dissolution can be expected to depend on the surface area of resin in contact with acetone, it was deemed logical to minimize RMD-related errors by utilizing (per availability of irradiated samples) a practical sample mass of ˜0.4 g, using resin beads as close to being identical to each other. Consequently, ten PLA resin beads (each ˜0.04 g, ˜4 mm OD) were selected for each RMD-related experiment.

Two different (temperature-controlled) water bath devices were used for the experiments: Oakton™ StableTemp® and Joanlab®, respectively. Each water bath was characterized for stable attainment of the temperature of the water bath with the temperature of the acetone-bearing containers for the duration of each RMD measurement. About 40 mL of acetone was utilized for each RMD experiment. The acetone was placed in a beaker and preheated to the desired temperature in a water bath positioned within a fume hood. To avoid significant evaporative loss of acetone, the temperature was kept below the boiling point of acetone, 56° C. (at 0.1 MPa). Three or four beakers are heated together each time, meaning 3-4 PLA resin samples (each ˜0.4 g total) were able to be prepared simultaneously during each experimental run.

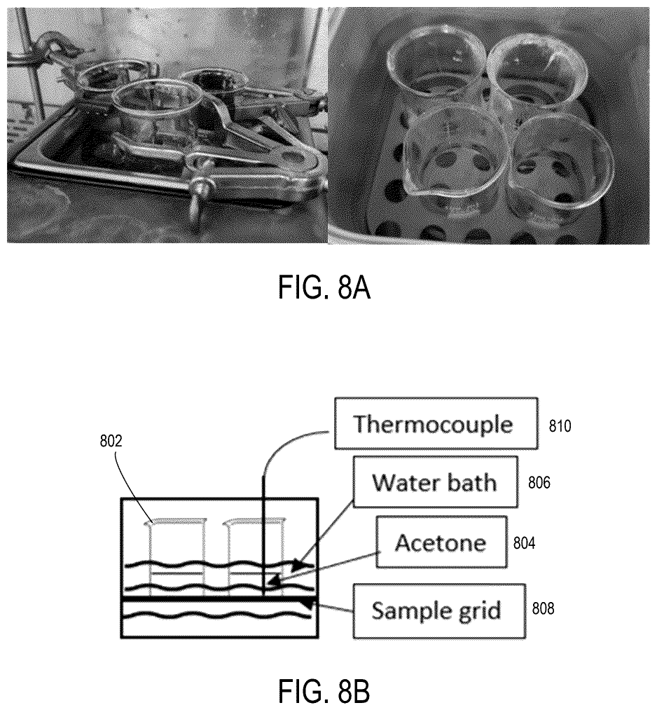

Before putting in the PLA beads and before removing the beakers, the temperature inside the acetone (in every single beaker) was measured with a Digi-Sense® Type J/K thermocouple meter combined with an Omega™ type-K prob) and averaged from among the beakers. According to the specifications provided by the manufacturer, the probe's precision is between 0.5° C. and 2.2° C., while the meter is 0.5° C. The overall uncertainty from the thermocouple was then taken as 2.2° C. Regardless, it was noted that the indicated temperature stays relatively constant (less than 0.5° C. variation), even considering that as time passes and the acetone evaporates, the temperature in acetone may change. The setup of the experiment is shown in in FIGS. 8A and 8B.

In FIG. 8A, actual photographs of the setup are shown, with the StableTemp® water bath shown at left and the Joanlab® water bath shown at right. For the StableTemp® water bath, clamps were used to hold the beakers to avoid direct contact between the beakers and the bottom of the water bath. For the Joanlab® water bath, a sample grid was used to prevent direct contact of the beakers and the bottom of the water bath. FIG. 8B shows a schematic (for the Joanlab® setup) of how the temperature was measured in each beaker. In FIG. 8B, a plurality of beakers 802, each containing a quantity of acetone 804 and of PLA (not shown), are placed in a water bath 806. A sample grid 808 is used to prevent direct contact between the beakers 802 and the bottom of the water bath in order to ensure proper thermal flow. Note that in other implementations, such as the StableTemp® implementation, the sample grid 808 may be replaced with another holding device, such as clamps. A thermocouple 810 is used to measure the temperature of the acetone 804. The thermocouple was inserted directly into acetone instead of the water bath.

For the StableTemp® water bath, the actual temperature in the water was ˜1° C. above the setup value measured at the same level where the beakers are held, and the average temperature in acetone among beakers is 0.6±0.3° C. below the setup value; for the Joanlab® water bath, the actual temperature in the water was ˜2° C. above the setup value and the average temperature in acetone among beakers is 0.5±0.5° C. above the setup value, as measured with the thermocouple. The temperatures mentioned above and below correspond to the temperatures measured by the inserted thermocouple.

The PLA beads were subjected to dissolution in the preheated acetone-bearing beaker for a 20-minute time duration (chosen from experiential learning). After the 20-minute dissolution, the beakers were removed from the water bath, followed by drainage of the acetone and separation of the remaining PLA resin.

From experience, it was noted that PLA dissolution in acetone is very low at ˜20° C. The scoping study results shown in FIG. 7 showed that significant mass dissolution is readily attainable over the 10-100 kGy range (for gamma irradiation dose) when the acetone temperature reaches ˜50° C., i.e., as the acetone approaches its 56.2° C. boiling point. Therefore, the useful temperature range was deemed to lie between 20+° C. and below 56° C. to study the effect of temperature-based activation of dissolution from neutron and/or gamma radiation-induced absorbed energy (i.e., dose) in PLA. The temperature range used for these experiments varied from a low of ˜40° C. to a high of ˜54° C.

Prior to the experimentation performed in support of the present disclosure, it was unclear as to what level of effect neutron radiation dose would have on mass dissolution compared to the effects from gamma radiation dose. Gamma radiation (at least for photon energies below 1.2 MeV) interactions with atoms are known to mainly be governed by interaction with the 10,000× larger (˜10⁻¹¹ m) size electron cloud surrounding the individual (˜10⁻¹⁵ m size) nuclei of atoms in the bulk of materials; that is, via photoelectric and Compton scattering phenomena. On the other hand, neutrons (uncharged neutral particles) remain blind to electrons surrounding nuclei of atoms and interact only with the nucleus of atoms in a variety of ways ranging from elastic/inelastic scattering, to photon production, to charged particle/neutron generation, to nuclear fission. In this way, neutron radiation can create heavy charged ion recoils on a localized (sub-nm) basis, creating ion-electron pairs within molecules over short ranges of a few microns. Because chemistry-related phenomena (including dissolution) are governed via electron exchange, it was assumed that for the same total radiation dose, the effect on mass dissolution will be greater for gamma photons and neutrons. Thus, it was hypothesized that the activation thermal energy (tied to the temperature of acetone) required for initiation of mass dissolution would be lower for gamma radiation-dosed samples. For the same radiation energy-based absorbed dose and acetone temperature, earlier onset of mass dissolution was hypothesized to occur for PLA samples subject to gamma radiation. If this hypothesis were correct, it would be possible to discriminate the neutron and gamma flux fields within a nuclear reactor in addition to discriminating neutron versus gamma radiation fields.

After being subjected to acetone for a duration of 20 minutes, the PLA resin sample was next placed in a preheated oven at ˜77° C. (170° F.) for ˜30 minutes for drying, before the sample was weighed again.

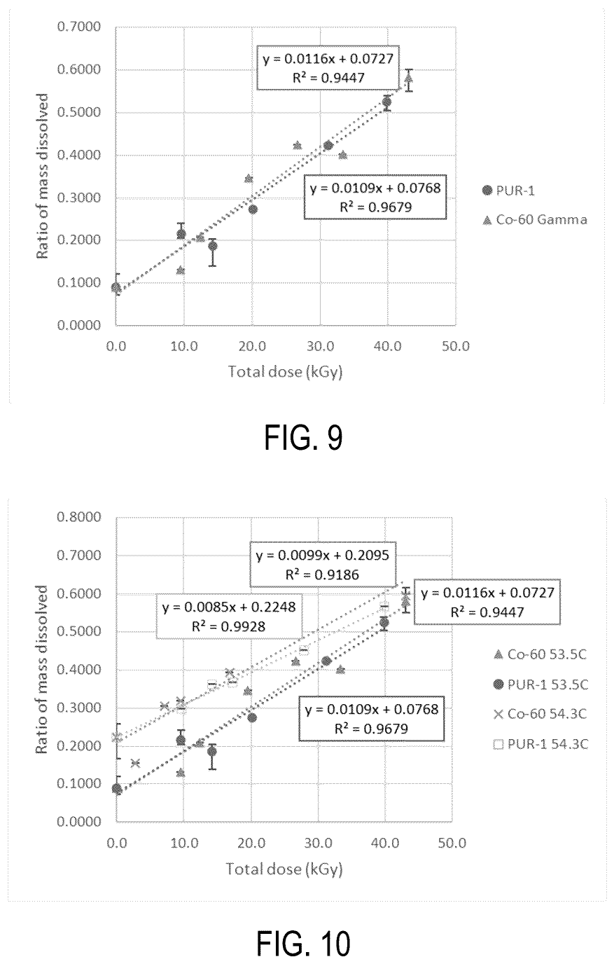

For select combinations of dose and temperature, the RMD values were obtained with 3-4 samples. Otherwise, a single sample was examined for gauging trends and threshold values of onset of effects on RMD for neutron versus gamma radiation effects. Results of RMD for the range of combination of parameters are shown in FIGS. 9-13 and discussed in more detail below. In FIGS. 9-13, error bars (where shown) depict the range of RMDs for that experiment. Where multiple samples were examined, the mean value and spread of data about the mean value are shown. Table 2 summarizes the testing range of experimental combinations.

TABLE 2
Test matrix of experiment combinations for RMD determinations

| | Irradiation Source Type | |
|---|---|---|
| Acetone Bath Temperature | Co-60 Gamma | PUR-1 Fission (Neutron and Gamma) |
| (° C.) | Dose Range | Dose Range |
| 40.5, 45.5, 53.5, 54.3 | 0 to ~43 (multiple) | 0 to 40 (multiple) |
| (No pre-heating) | | |
| 54.3 | 0 and ~43 | 40 |
| (Pre-heating PLA in oven at | | |
| 300° C. for 30 s) | | |

Results of experiments over the 1-40 kGy range with Co-60 gamma irradiation and PUR-1 neutron and gamma irradiation are plotted in FIG. 9. As noted from FIG. 9, the RMD values over the 1-40 kGy range from mass dissolution tests conducted with acetone at 53.5° C. are generally compatible with each other, regardless of the radiation source or even their respective energy spectra. This indicates that acetone at 53.5° C. provides activation energy for mass dissolution that is far above the threshold energy required for the onset of PLA dissolution regardless of the type of radiation used or even without any irradiation. While this finding permits one to correlate radiation dose with RMD and perform dosimetry within +10% accuracy over a wide range of radiation doses, it does not by itself allow discrimination between the contribution from neutron and gamma radiation components.

As further affirmation of the above conclusion pertaining to the activation energy for dissolution via temperature state, experiments were conducted at an even higher temperature of 54.3° C., which is closer to the boiling point. In order to assess for reproducibility, several tests were conducted with 0 and 43 kGy Co-60 y source irradiated resin samples; the 1 σ value remained <0.05. The results of experiments at 54.3° C. are shown in FIG. 10. Once again, the RMD values for irradiated PLA with either Co-60 gammas or PUR-1 neutrons and gammas are compatible with each other over the 40 kGy range.

From FIGS. 9 and 10, a trend can be observed. While the RMD values for 40 kGy total dose are similar to experiments at 53.5° C. and 54.3° C., the spread widens with a reduced dose. At the extreme low end (i.e., 0 kGy), a 1° C. difference in acetone temperature leads to a doubling of the RMD. Dissolutions with acetone at temperatures above 54.3° C. were not attempted to in this experiment, but may be conducted in sealed (pressurized) vessels.

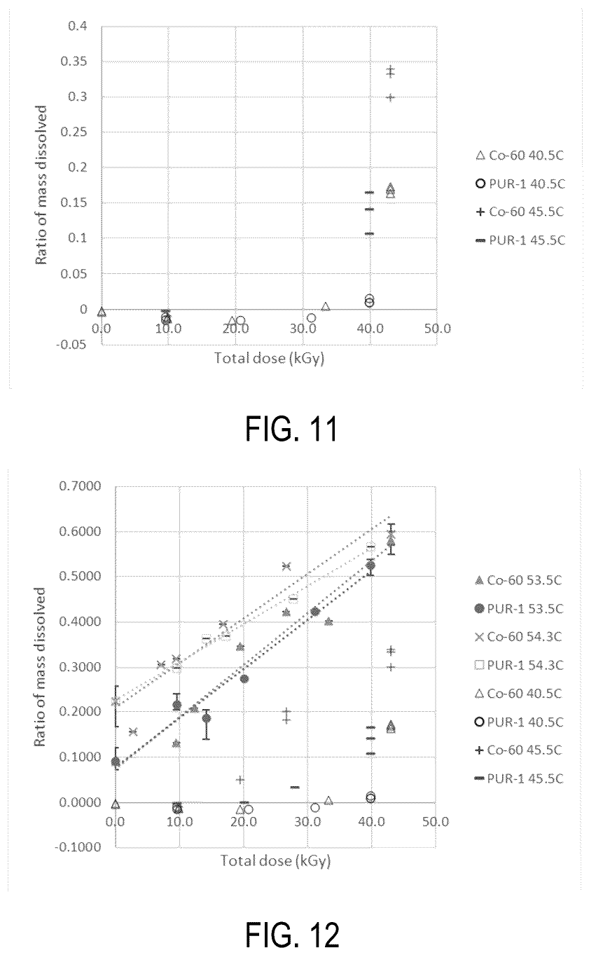

Further analysis was performed to assess threshold temperatures for activation of dissolution for allowing discrimination of neutron versus gamma radiation. It was ascertained that at room temperature (˜21.5° C.), the RMD value remained close to zero. However, changes became apparent when the acetone temperature rose at and above ˜40.5° C. Results of scoping tests are shown in FIG. 11. As seen from FIG. 11, for total dose levels below ˜30 kGy, the RMD values are actually below zero, i.e., indicative of acetone mass uptake into PLA resin versus dissolution for acetone temperatures below 45.5° C. An inflection point occurs for dose levels above 30 kGy for acetone temperatures at/above 40.5° C. For the dose level of ˜40 kGy, a sharp increase in RMD occurs at ˜40.5° C., but only for the Co-60 irradiated sample and not for the combined PUR-1 sample. FIG. 12 is a composite plot showing the RMD variation with total radiation dose and temperature.

This facilitates a conclusion in relation to the activation of dissolution via irradiation from gamma photons. While the Co-60 irradiation is mainly from gamma photons, the PUR-1 irradiation dose at 40 kGy is split roughly 50/50 between gamma and neutron doses, respectively. Effectively, at a total PUR-1 dose of 40 kGy, the gamma dose component is only ˜20 kGy (as noted in Table 1). The intermolecular bond damage caused at 20 kGy dose coupled with thermal energy activation at 45.5° C. is not sufficient to lead to significant mass dissolution. This explains why the RMD rises to ˜0.17 at a total dose of 40 kGy deposited from Co-60 gamma rays. Only once the acetone temperature rises towards 45° C. does the RMD for the 40 kGy (PUR-1) irradiated sample rise to RMD ˜0.15, and the ˜43 kGy (Co-60) irradiated sample RMD rises towards ˜0.32, which is ˜2.2× greater than for the PUR-1 sample. This difference in RMD at ˜40 kGy (total dose) between the Co-60 and PUR-1 cases correlates directly to the ability to discriminate between and discern the neutron versus gamma radiation-induced dose components, respectively. That is, even at 45.5° C., the activation (thermal) energy is sufficient to lead to mass dissolution of PLA as caused only by gamma irradiation, but not yet from neutron radiation dose. Only when the temperature rises at/above 50° C. does the activation energy for dissolution exceed the level necessary for both neutron and gamma irradiation.

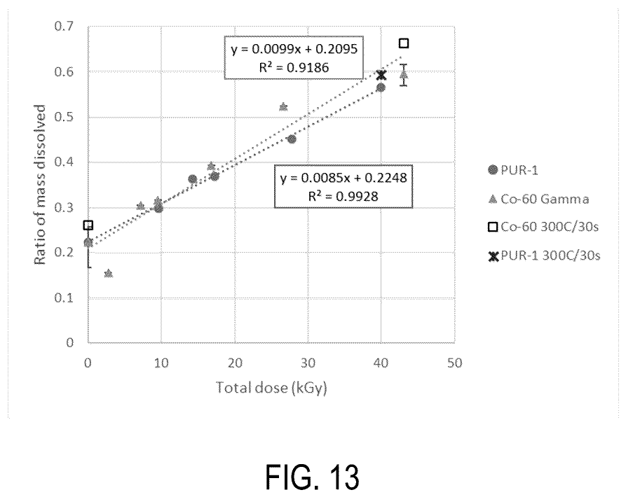

The irradiation dose of up to ˜40 kGy required about 6 h irradiation time in PUR-1 (operating at a power of 8 KW) wherein the neutron flux was ˜1010 n/cm²/s, and the coolant temperature was ˜20° C. In contrast, the average neutron flux in a typical 3 GW LWR is 1,000× higher at ˜1013 n/cm²/s, and the core averaged coolant temperature is about 300° C. Assuming a linear relationship with neutron flux, the equivalent amount of irradiation time to attain ˜40 kGy doses in a power reactor core scales to about 21 seconds and could be readily achieved by moving PLA resin samples in-out of the core via instrument guide tubes. Further investigation was performed to determine the impact on RMD when the irradiated PLA resin is subject to a 300° C. temperature air environment for a 20-30 second time frame. In order to shed light on this question, PLA samples at total irradiation dose levels of 0 and 40 kGy (via Co-60 and PUR-1) were kept in a preheated oven at an air temperature of ˜300° C. air environment for 30 seconds, after which they were assessed for RMD via being subjected to mass dissolution testing in acetone bath temperature of 54.3° C. The results are shown in FIG. 13, together with earlier results obtained with irradiations conducted at ˜20° C. As noted from FIG. 13, the RMD data obtained with 300° C. post-heating for 30 seconds are in close proximity of the data obtained via irradiation at 20° C. This finding evidences the potential for monitoring the neutron and gamma flux fields in an operating LWR.

The present disclosure presents a biomaterial-based solid-state gamma/neutron radiation dose monitoring metric, Mass Loss upon Dissolution (MLD), as a technique for PLA resin-based neutron and gamma radiation monitoring. The technique derives the ratio of mass dissolved (RMD) as a metric for determining the radiation dose from neutron and gamma radiation fields, in addition to offering the possibility for discriminating between the relative components of the two radiation types. Irradiations were conducted using a Co-60 bearing GammaCell™ for gamma dose, and by using PUR-1 for nuclear fission neutron-cum-gamma radiation dose. The total dose varied from 0 to 40 kGy for samples irradiated in PUR-1 and from 0 to 130 kGy for samples irradiated in the GammaCell™, respectively.

RMD values were determined by subjecting the irradiated PLA samples to dissolution in an acetone bath for 20 minutes at temperatures ranging from 20° C., 40.5° C., 45.5° C., 53.5° C., and 54.5° C., respectively. Little to no RMD variation was noted for acetone bath temperatures below 40.5° C., after which a sudden threshold activation energy effect manifested itself, offering the potential for not only monitoring but also to separately allow discrimination and determination of the neutron and gamma dose components, respectively, at the acetone bath temperature of 45.5° C. For tests conducted at/above 50° C., a linear trend was obtained for RMD vs. total dose irrespective of radiation type, neutron or gamma.

The extension of the results obtained for RMD variations via PUR-1 irradiations at 20° C. was assessed in scoping fashion for application to the possibility of monitoring and mapping the neutron and gamma radiation field intensities in a 3 GW power reactor coolant environment of 300° C. The equivalent RMD values over the radiation dose range of 0 to 40 kGy were generally compatible with each other. The PLAD-based approach based on RMD, evidenced by conducting dissolution for about 20 minutes in acetone at ˜53° C. for the in-core power and neutron-gamma flux fields (and associated dosimetry) is feasible to conduct within one hour (e.g., less than or equal to thirty minutes. In such a scenario, the PLAD resin may be possible to utilize for short duration (e.g., <1 minute) core-wide irradiation using instrument guide tubes.

It should be noted that, while the above experimentation used acetone as the solvent, other solvent alternatives may be used for relative dissolution of PLA. For example, solvents such as ethyl acetate, methyl ethyl ketone, propylene carbonate, pyridine, chloroform, or corrosive alkaline solutions (e.g., NaOH-water) may be used. However, depending on the solvent used, higher solvent temperatures may be needed to derive results within one hour. Acetone may be used in practical implementations because it is inexpensive, readily available, and user-friendly.

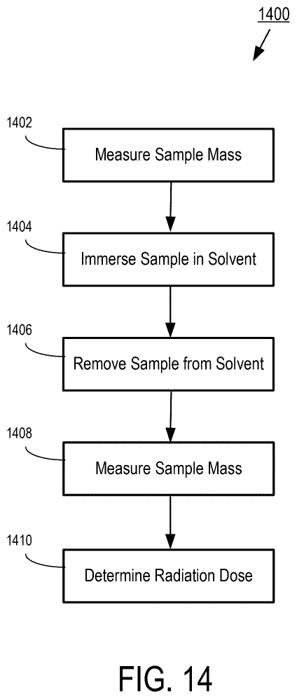

FIG. 14 illustrates an example of a method 1400 for measuring a radiation dose in accordance with the above techniques and experiments. The method 1400 includes an operation 1402 of measuring a mass of a sample, such as a PLA resin-based sample. For example, the mass of the sample may be measured using a scale. The sample may be in the form of one or more beads of PLA. Operation 1402 occurs after the sample has been subjected to the radiation dose. Thus, operation 1402 may, in some examples, be preceded by an operation of subjecting the sample to the radiation dose. The radiation dose may include a gamma radiation dose and a neutron radiation dose.

This pre-procedure may include positioning the sample in a testing area for a predetermined period of time, the testing area being an area where neutron radiation, gamma radiation, or both neutron and gamma radiation is present. In some examples, the testing area may be the core of a fission nuclear reactor (e.g., an LWR) during operation of the reactor. In other examples, the testing area may be within a particle accelerator (e.g., a medical treatment accelerator, a research accelerator, etc.). The amount of time during which the sample is positioned in the testing area may be based on an environmental condition of the testing area. For example, for a LWR core having a high radiation dose rate and a high temperature, the amount of time may be less than or equal to one minute. The sample may be first placed in a sample assembly (e.g., a cartridge in an aluminum tube, as described above with regard to FIG. 4), then inserted into an access tube of the device being tested (e.g., an instrument guide tube of the fission nuclear reactor). After the amount of time has elapsed, the sample assembly may then be removed from the access tube.

After obtaining the mass of the sample prior to radiation, at operation 1404 the sample is immersed in a solvent at a predetermined temperature for a predetermined amount of time. The solvent may be acetone in some examples. However, in other examples, the solvent may be another material that dissolves PLA, such as ethyl acetate, methyl ethyl ketone, propylene carbonate, pyridine, chloroform, or a corrosive alkaline solution. The temperature at which the solvent is held during operation 1404 may correspond to a temperature at which the solvent dissolves a gamma-irradiated portion of the sample but does not dissolve a neutron-irradiated portion of the sample. Thus, the temperature may be based on the identity of the solvent. For example, if the solvent is acetone, the temperature at which the solvent is held during operation 1404 may be between 40.5° C. and 45.5° C. The period of time may also be based on the identity of the solvent, and in some implementations may additionally or alternatively be based on the temperature. The period of time may be less than or equal to one hour to ensure increased usability of the method of detection (e.g., by providing results quickly). Operation 1406 may be performed using the setups shown in FIGS. 8A and 8B or another comparable setup.

After the period of time has elapsed, at operation 1406 the sample may be removed from the solvent. For example, the vessel containing the sample and solvent may be drained to separate the sample and the solvent. In some examples, operation 1406 may further include drying the sample (e.g., in a preheated oven) to further remove the solvent.

At operation 1408, the mass of the sample is measured again (e.g., using a scale). At operation 1410, a measurement the radiation dose is determined. Operation 1410 may include storing the measurement of the radiation dose in a local memory, transmitting the measurement to another device, and the like. Operation 1410 may be based on the mass values measured before and after immersion in the solvent. In some examples, operation 1410 may include determining the RMD, as set forth in Equation (1) above.

The method 1400 may be used with multiple samples in order to map a radiation dose. For example, a plurality of samples may be prepared, each containing PLA. Each of these samples may be subjected to a different location in a radiation environment (e.g., a different location within a reactor core). Then, the method 1400 may be performed for each of the samples to determine the MLR (and thus the corresponding radiation dose). Based on the MLR and the location of the samples within the radiation environment, a map of the radiation dose may be generated.

In some examples, the methods set forth herein may be implemented with a dose analysis or measurement device that includes at least one processor and at least one memory. The device may be configured to receive inputs representative of measurement parameters and results, including but not limited to the initial mass of a sample prior to immersion in the solvent, the final mass of the sample after immersion in the solvent (e.g., after drying or other solvent removal treatment), the temperature of the solvent, the identity of the solvent, and the like. The device may be configured with various modules (e.g., various software modules) to implement radiation dose analysis functions. In an example, the modules may be present in a non-transitory computer-readable medium (e.g., the memory) in the form of instructions that, when executed by the processor, cause the device to perform any one or more of the operations described herein. In another example, the processor may be configured to load and/or execute instructions from another non-transitory computer-readable medium (e.g., cloud storage or from the memory of another device).

The processor may include one or more individual electronic processors, each of which may include one or more processing cores, and/or one or more programmable hardware elements. The processor may be or include any type of electronic processing device, including but not limited to central processing units (CPUs), graphics processing units (GPUs), application-specific integrated circuits (ASICs), field-programmable gate arrays (FPGAs), microcontrollers, digital signal processors (DSPs), or other devices capable of executing software instructions. When a device is referred to as “including a processor,” one or all of the individual electronic processors may be external to the device (e.g., to implement cloud or distributed computing). In implementations where a device has multiple processors and/or multiple processing cores, individual operations described herein may be performed by any one or more of the microprocessors or processing cores, in series or parallel, in any combination. In some implementations, one or more of the processing units or processing cores may be remote (e.g., cloud-based).

The memory may be any storage medium, including a non-volatile medium, e.g., a magnetic media or hard disk, optical storage, or flash memory; a volatile medium, such as system memory, e.g., random access memory (RAM) such as dynamic RAM (DRAM), synchronous dynamic RAM (SDRAM), static RAM (SRAM), extended data out (EDO) DRAM, extreme data rate dynamic (XDR) RAM, double data rate (DDR) SDRAM, etc.; on-chip memory; and/or an installation medium where appropriate, such as software media, e.g., a CD-ROM, or floppy disks, on which programs may be stored and/or data communications may be buffered. The term “memory” may also include other types of memory or combinations thereof. For the avoidance of doubt, cloud storage is contemplated in the definition of memory. A memory is an example of a non-transitory computer-readable medium which stores instructions that are executable by a processor (or processors), the execution of which causes the executing device (e.g., a computer) to perform certain operations, such as those operations described herein.

Although the invention has been described and illustrated in the foregoing illustrative aspects, it is understood that the present disclosure has been made only by way of example, and that numerous changes in the details of implementation of the invention can be made without departing from the spirit and scope of the invention, which is limited only by any allowed claims that are entitled to priority to the subject matter disclosed herein. Features of the disclosed aspects can be combined and rearranged in various ways.

Other examples and uses of the disclosed technology will be apparent to those having ordinary skill in the art upon consideration of the specification and practice of the invention disclosed herein. The specification and examples given should be considered exemplary only, and it is contemplated that the appended claims will cover any other such aspects or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its aspects.

What is claimed is:

1. A method for measuring a radiation dose, the method comprising:
measuring a first value of a mass of a first sample, wherein the first sample includes a polylactic acid (PLA) resin, and wherein the first sample has been subjected to the radiation dose at a testing area;
immersing the first sample in a solvent at a first predetermined temperature for a first predetermined period of time;
removing the first sample from the solvent after the first predetermined period of time has elapsed;
measuring a second value of the mass of the first sample; and
generating a first measurement of the radiation dose based on the first value and the second value of the mass of the first sample.

2. The method of claim 1, wherein the radiation dose includes a gamma radiation dose and a neutron radiation dose.

3. The method of claim 2, wherein the first measurement corresponds to a total amount of the gamma radiation dose and the neutron radiation dose.

4. The method of claim 2, wherein, at the first predetermined temperature, the solvent dissolves a portion of the first sample that has been subjected to the gamma radiation dose and a portion of the first sample that has been subjected to the neutron radiation dose.

5. The method of claim 2, further comprising:
measuring a first value of a mass of a second sample, wherein the second sample includes the PLA resin, and wherein the second sample has been subjected to the radiation dose at the testing area;
immersing the second sample in the solvent at a second predetermined temperature for a second predetermined period of time, wherein the second predetermined temperature is different than the first predetermined temperature;
removing the second sample from the solvent after the second predetermined period of time has elapsed;
measuring a second value of the mass of the second sample; and
generating a second measurement of the radiation dose based on the first value and the second value of the mass of the sample.

6. The method of claim 5, wherein the second measurement corresponds to an amount of the gamma radiation dose but not to an amount of the neutron radiation dose.

7. The method of claim 5, wherein, at the second predetermined temperature, the solvent dissolves a portion of the second sample that has been subjected to the gamma radiation dose but does not dissolve a portion of the second sample that has been subjected to the neutron radiation dose.

8. The method of claim 5, wherein the predetermined temperature is between 40.5° C. and 45.5° C.

9. The method of claim 1, wherein the solvent is acetone.

10. The method of claim 1, further comprising:
prior to the operation of measuring the first value of the mass of the first sample, positioning the first sample in the testing area for a second predetermined period of time, wherein the testing area corresponds to an area where neutron radiation, gamma radiation, or both neutron and gamma radiation is present.

11. The method of claim 10, wherein the testing area is within a core of a fission nuclear reactor during operation.

12. The method of claim 11, wherein the operation of positioning the first sample in the testing area includes:
placing the first sample in a sample assembly;
inserting the sample tube into an instrument guide tube of the fission nuclear reactor; and
removing the sample assembly from the instrument guide tube after the second predetermined period of time has elapsed.

13. The method of claim 10, wherein the testing area is within a particle accelerator.

14. The method of claim 10, wherein the second predetermined period of time is based on an environmental condition of the testing area.

15. The method of claim 1, wherein the operation of removing the first sample from the solvent includes drying the sample to remove residual solvent.

16. The method of claim 1, wherein the first predetermined period of time is based on at least one of a material of the solvent or the first predetermined temperature.

17. The method of claim 1, wherein the first predetermined period of time is less than or equal to one hour.

18. The method of claim 1, wherein the first sample includes at least one bead of the PLA resin.

19. The method of claim 1, wherein the measurement of the radiation dose is based on a ratio of a difference between the first value of the mass of the first sample and the second value of the mass of the first sample, to the first value of the mass of the first sample.

20. A method for mapping a radiation dose, comprising:
preparing a plurality of samples, wherein the plurality of samples respectively include a polylactic acid (PLA) resin;
subjecting the plurality of samples to a radiation environment;
for each of the plurality of samples:
measuring a first value of a mass of the sample,
immersing the sample in a solvent at a predetermined temperature for a predetermined period of time,
removing the sample from the solvent after the predetermined period of time has elapsed,
measuring a second value of the mass of the sample, and
determining a ratio of mass dissolved of the sample; and
generating a map of the radiation dose based on respective ratios of mass dissolved for the plurality of samples and on respective locations within the radiation environment for the plurality of samples.
